(19) United States
(12) Patent Application Publication
(10) Pub. No.: US 2008/0086809 A1
(43) Pub. Date: Apr. 17, 2008

(54) Overmolded hydrotherapy equipment

(76) Inventor: Russ Wooten, Oxford, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/549,230

(22) Filed: Oct. 13, 2006

(51) Int. Cl. A61H 33/04

(52) U.S. Cl. 4/541.6

(57) ABSTRACT

Overmolded jets for hydrotherapy equipment components providing enhanced gripping capabilities and ease of manipulation for the occupant of the hydrotherapy equipment in underwater or wet conditions such that the ergonomics of hydrotherapy equipment jets are enhanced and improved.

### BACKGROUND OF THE INVENTION

1. Technical Field

The present invention is directed to hydrotherapy equipment components, and, more particularly, to jets and other wet-side water features for hydrotherapy equipment having an overmold incorporated therein to increase and enhance ergonomic aspects of the controllers.

2. Related Art

Conventional spas, hot tubs, whirlpool baths, swimming pools, showers and the like, hereinafter referred to and defined as hydrotherapy equipment, comprise jet heads, nozzles, shower heads and waterfalls or features, hereinafter referred to collectively and defined as jets. Such jets allow the occupant to control various components within the hydrotherapy equipment.

By way of example, typical hydrotherapy equipment in the nature of hot tubs spas or bathtubs with jets formed therein are constructed as a molded shell to form a water containment or fluid enclosure having a footwell or floor and an upstanding sidewall. Molded within the enclosure are a plurality of therapy stations which may include seats or platforms for reclining. The shell typically is constructed of fiberglass, plastic or a similar material, or a composite of such materials. One or more pumps usually are placed under the shell to draw water from the enclosure and discharge it, usually with air, into the enclosure through a plurality of nozzles or jets of various types, including venturi-type jets. The jets usually are mounted through the shell in either or both of the floor and sidewall. Typically, jets mounted through the sidewall are located below the water line of the spa, and in any event, the jets are designed to provide a comforting or therapeutic effect to a person occupying a therapy station.

The occupant may redirect the jets by gripping the underwater jet controller and moving it vertically and/or horizontally. The occupant also may control the amount of water and air being jetted by the jet, and thus the force of the jet, by twisting or turning a jet controller. Similarly, wet-side aesthetic features such as waterfalls and waterspouts can be controlled by pulling, pushing, lifting or twisting the feature, often at or immediately proximal to the water outlet. Various other controllers for controlling components within the tub, for example, lighting, heat, force of water/air flow and the like, are typically present along the sidewall of the spa or tub. Each of these controllers is, in ordinary use, wet and slippery, often requiring extraordinary effort at times to control the components. Similarly, hydrotherapy equipment in the way of showers comprise components that are controllable, for example, the direction, force, volume and type of water flow desired are all controlled generally via the showerhead controller. As mentioned above, the occupant also may control the direction, force, volume and type of water flow desired by twisting or turning a controller.

Due to ordinary construction and the environment of use of hydrotherapy equipment, such equipment typically has surfaces which are wet and slippery, especially the jet discussed herein, as they typically are located at or below the waterline. These wet and slippery conditions provide generally non-ergonomic conditions for the occupant when he or she wishes to modify the hydrotherapy equipment environment. Thus, conventional jets in hydrotherapy equipment make it difficult for some occupants to form a firm grip on a jet, making subsequent manipulation of the jet, and thus the efficiency and efficacy of the jet stream, virtually impossible for some.

Accordingly, there is a need for a device that allows for the increased and enhanced manipulation of hydrotherapy equipment jets. It is to this need and others that the present invention is directed.

### BRIEF SUMMARY OF THE INVENTION

The present invention provides overmolded jets for hydrotherapy equipment. The overmolded jet provides enhanced gripping capabilities and ease of manipulation for the occupant of the hydrotherapy equipment in underwater or wet conditions. In this manner, the ergonomics of hydrotherapy equipment jets are enhanced and improved.

Briefly, an exemplary jet component of the present invention for hydrotherapy equipment may be used in a hot tub spa or bathtub to control the volume, composition, temperature, direction and other aspects, of water and air flowing through the jets. The jet comprises a housing with an overmolding formed thereon to provide grippable portions for the user's fingers and/or palm when the user engages the housing. The overmolding covers at least a part of a grippable portion engageable by the user's hand. The surface of the overmolding of the jet may be raised and/or beveled in relation to the housing surface. Additionally, the overmolding may have a textured and/or a patterned surface to enhance gripping and manipulation of the jet.

The overmolding of the spa component of the present invention is injection molded over the substrate component jet housing by, for example, dual-shot or multi-shot processes. The overmolding of the jet of the present invention may comprise an elastomeric resin. The material selected for the overmolding may be resilient, waterproof and have an ability to adhere to the substrate jet that is generally comprised of a plastic material.

The gripping ergonomic enhancement provided by the present invention results from, in part, differences in the materials used for the component housing and the overmold. Thus, in one embodiment the jet may comprise a component housing formed from a material with a certain coefficient of friction and an overmolding formed on the housing, wherein the overmolding material has a certain coefficient of friction that is greater than that of the housing material. In this manner, the jet's gripping ergonomics, that is, ease of gripping and manipulating, are improved and enhanced. In addition, various embodiments of the present invention may comprise materials in the housing and the overmolding that differ relative to each other in terms of hardness or softness. In a preferred embodiment, the overmolding material is softer than the material of the housing to enhance the gripping ergonomics of the jet.

Moreover, various embodiments of the invention may comprise at least a portion of the overmolding being raised and/or beveled relative to the component housing to enhance the gripping ergonomics thereof. The invention may further comprise overmolding with textures or patterns to enhance the user's ability to grip and manipulate the jet. Thus, one feature of the invention is enhanced and improved gripping ergonomics of hydrotherapy equipment jets. Another feature of the invention is a hydrotherapy equipment jet that is easily grippable and manipulated in wet environments.

These features, and other features and advantages of the present invention will become more apparent to those of ordinary skill in the relevant art when the following detailed description of the preferred embodiments is read in conjunction with the appended drawings in which like reference numerals represent like components throughout the several views. The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 is a first embodiment of a representative exemplary jet for hydrotherapy equipment of the present invention.

FIG. 2 is second embodiment of a representative exemplary jet for hydrotherapy equipment of the present invention.

### DETAILED DESCRIPTION OF THE PREFERRED EMBODIMENTS

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention. Thus, it will be understood that the hydrotherapy equipment jets described and illustrated herein are exemplary and, as defined herein, comprise jets, nozzles, shower heads, waterfalls, waterspouts, water features, and the like, each of which is within the scope of the present invention.

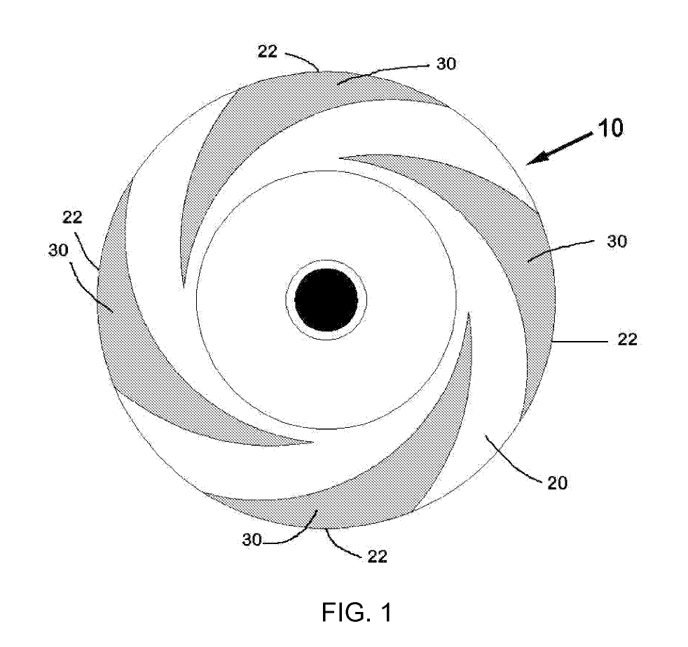

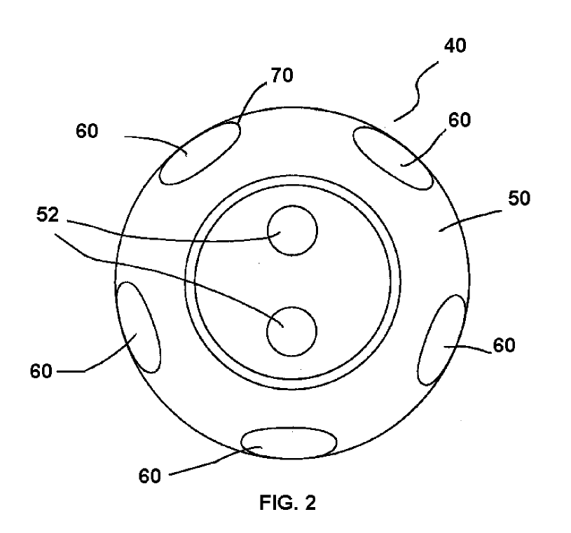

FIG. 1 is a first embodiment of a representative exemplary jet for hydrotherapy equipment of the present invention showing the possible placement of overmolded portions. FIG. 2 is a second embodiment of a representative exemplary jet for hydrotherapy equipment of the present invention also showing the possible placement of overmolded portions.

FIG. 1 illustrates first exemplary jet 10 for hydrotherapy equipment. Such a jet 10 may be used, in an illustrative embodiment, in a hot tub spa or bathtub to control the volume and direction of water and air flowing through the jet into the spa. The jet 10 of FIG. 1 comprises a housing 20 with an overmolding 30 formed thereon. The housing 20 is formed to provide grippable portions 22 for the user's fingers as well as grippable portions for the palm of the user's hands when the user's fingers engage the housing 20. The overmolding 30 is illustrating covering at least a part of a grippable portion engageable by the palm of the user's hand. In alternate embodiments, at least some of the grippable portions 22 for the user's fingers also may be overmolded. In other alternate embodiments, only the grippable portions 22 for the user's fingers are overmolded. Those skilled in the art will recognize that various equivalent embodiments exist, each having at least part of at least one grippable portion covered by an overmold to enhance gripping thereon.

The surface of the overmolding 30 of the jet 10 of FIG. 1 may be raised and/or beveled in relation to the housing surface 20. Additionally, the overmolding 30 may have a textured and/or a patterned surface to enhance gripping and rotation of the jet 10. For example, dots, lines, waves, ridges, and the like can be formed onto the housing surface 20 under the overmolding 30, or the overmolding 30 itself may comprise dots, lines, waves, ridges, and the like to enhance the user's ability to grip the housing 20.

FIG. 2 illustrates a second exemplary jet 40 of the present invention, in this example, a spinning jet. The jet 40 comprises a control ring 50 and overmolded portions 60. Water and air outlets 52 are defined within a central spinning element of the device. The control ring 50 is manipulated by the user to control the volume of the water/air flow from the outlets 52 within the spa or bathtub by rotating the control ring 40.

The overmolding 30, 60 of the spa component of the present invention preferably is injection molded over the substrate housing 20, 50 by methods that are well known to those skilled in the art, including but not limited to, dual-shot or multi-shot processes or insert molding techniques. The overmolding of the spa jet of the present invention may comprise an elastomeric resin. For example, the overmolding may comprise, without limitation, thermoplastic elastomer (TPE) and thermoplastic vulcanizates (TPV) as well as other thermoplastics and silicones, including combinations of thermoplastics and of thermoplastics and silicones. The material selected for the overmolding may be resilient, waterproof and have an ability to adhere to the substrate that is generally comprised of a plastic material, including but not limited to acrylonitrile butadiene styrene (ABS), acrylonitrile ethylene styrene (AES), polycarbonate (PC), thermoset plastics, ceramics, metals, glass, and the like. Those skilled in the art will recognize a range of equivalent materials, each of which is within the scope of the present invention.

The gripping ergonomic enhancement provided by the present invention results from, in part, differences in the materials used for the component housing and the overmold. For example, all materials have a coefficient of friction. The coefficient of friction is simply a measure of the slipperiness between two surfaces. The larger the coefficient of friction, the less slippery the surfaces. In addition, the resistance to lateral motion when one attempts to slide the surface of one object over another surface, that is, a hand over a spa component, is friction. The frictional force depends on the normal force, which is the force pressing the two surfaces together as well as the types of materials from which the surfaces are formed, that is, some materials are more slippery than others. Thus, the present invention provides, among other things, a user with the ability to manipulate a spa controller with less frictional force than known controllers.

Thus, for example, with reference to FIG. 1, in one embodiment the jet 10 of the present invention may comprise a component housing 20 formed from a material with a certain coefficient of friction and an overmolding 30 formed on the housing 20, wherein the overmolding 30 material also has a certain coefficient of friction. Various embodiments of the present invention may comprise a housing material and an overmolding material with coefficients of friction that differ from each other. In a preferred embodiment, the overmolding material will have a coefficient of friction that is greater than that of the housing material. In this manner, the jet's 10 gripping ergonomics, that is, ease of gripping and manipulating, are improved and enhanced.

In addition, various embodiments of the present invention may comprise materials in the housing and the overmolding that differ relative to each other in terms of hardness or softness. In a preferred embodiment, the overmolding material is softer than the material of the housing to enhance the gripping ergonomics of the controller.

Moreover, various embodiments of the invention may comprise at least a portion of the overmolding being raised and/or beveled relative to the component housing to enhance the gripping ergonomics thereof. The invention may further comprise overmolding with textures or patterns to enhance the user's ability to grip and manipulate the controller.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A hydrotherapy equipment jet, comprising:
a) a component housing, the housing having at least one grippable portion; and
b) an overmolding formed upon at least part of the at least one grippable portion of the housing.

2. The hydrotherapy equipment jet of claim 1, wherein the component housing comprises a material selected from the group consisting of acrylonitrile butadiene styrene, acrylonitrile ethylene styrene, polycarbonate, thermoset plastics, ceramics, glasses, and combinations thereof.

3. The hydrotherapy equipment jet of claim 1, wherein the overmolding comprises a material selected from the group consisting of elastomeric resins, thermoplastic elastomers, thermoplastic vulcanizates, silicones, and combinations thereof.

4. The hydrotherapy equipment jet of claim 1, wherein the component housing comprises a material having a coefficient of friction, and the overmolding comprises a material having a coefficient of friction that is different than the coefficient of friction of the material of the component housing.

5. The hydrotherapy equipment jet of claim 4, wherein the overmolding material's coefficient of friction is greater than the component housing material's coefficient of friction.

6. The hydrotherapy equipment jet of claim 4, wherein the overmolding material is softer than the component housing material.

7. The hydrotherapy equipment jet of claim 1, wherein the overmolding comprises a textured pattern.

8. The hydrotherapy equipment jet of claim 1, wherein at least a portion of the overmolding is raised relative to the component housing.

9. The hydrotherapy equipment jet of claim 8, wherein at least a portion of the overmolding is beveled.

10. A hydrotherapy equipment jet, comprising:
a) a component housing, the housing having at least one grippable portion and formed from a material having a first coefficient of friction; and
b) an overmolding formed upon at least part of the at least one grippable portion of the housing and formed from a material having a second coefficient of friction,
wherein the first coefficient of friction of the overmolding material is greater than the second coefficient of friction of the material of the component housing, and
wherein the overmolding material is softer than the component housing material.

11. A method of making a hydrotherapy equipment jet, comprising the steps of:
a) forming a component housing of a first material having a first coefficient of friction; and
b) overmolding a second material having a second coefficient of friction upon at least a portion of a grippable surface of the component housing,
wherein the first material is different than the second material and the first coefficient of friction is less than the second coefficient of friction.

12. The method of claim 11, wherein the second material is softer than the first material.
